(19) United States
(12) Patent Application Publication
(10) Pub. No.: US 2005/0105609 A1
(43) Pub. Date: May 19, 2005

(54) System and method for temporal out-of-order compression and multi-source compression rate control

(75) Inventors: William C. Lynch, Palo Alto, CA (US); Steven E. Saunders, Cupertino, CA (US); Krasimir D. Kolarov, Menlo Park, CA (US)

Correspondence Address: Zilka-Kotab, PC, P.O. BOX 721120, SAN JOSE, CA, 95172-1120, US

(73) Assignee: DROPLET TECHNOLOGY, INC.

(21) Appl. No.: 10/955,240

(22) Filed: Sep. 29, 2004

Related U.S. Application Data
(60) Provisional application No. 60/507,148, filed on Sep. 30, 2003.
(60) Provisional application No. 60/507,147, filed on Sep. 30, 2003.
(60) Provisional application No. 60/612,311, filed on Sep. 21, 2004.

(51) Int. Cl. H04B 1/66

(52) U.S. Cl. 375/240.01

(57) ABSTRACT

A system, method, and computer program product are provided for temporal video compression. In use, portions of video are buffered in a first order. Further, the portions of video are at least partially temporally compressed in a second order. Another system, method, and computer program product are further provided for compressing video from a plurality of sources. In use, video is received from a plurality of sources. Such video from the sources is then compressed. Such compression is carried out using a plurality of rate controls. In various embodiments, the video may be received by way of a single video stream, and/or the compression may be carried by way of a single compression module.

### RELATED APPLICATION(S)

The present application claims priority to provisional applications filed Sep. 30, 2003 under Ser. Nos. 60/507,148 and 60/507,147, which are incorporated herein by reference in their entirety. The present application is further related to a provisional application entitled “Rate Control With Variable Sub-band Quantization” which was filed Sep. 22, 2004 under Ser. No. 60/______ and named the same inventors, and which is further incorporated herein by reference in its entirety.

### FIELD OF THE INVENTION

The present invention relates to data compression, and more particularly to compressing visual data.

### BACKGROUND OF THE INVENTION

Since directly digitized images and video require a massive amount of bits, it is common to compress such images and video for storage, transmission, and other uses. Several basic methods of compression are known, as well as many specific variants of these.

One particular prior art compression method can be characterized by a three-stage process involving a transform stage, a quantize stage, and an entropy-code stage. In use, the transform stage operates to gather energy or information of a source into a format that is compact by taking advantage, for example, of local similarities and patterns in the picture or sequence. Many image compression and video compression methods, such as MPEG-2 and MPEG-4, use a discrete cosine transform (DCT) as the transform stage for compression purposes. Further, newer image compression and video compression methods, such as MPEG-4 textures, use various wavelet transforms as the transform stage.

A wavelet transform comprises a repeated application of wavelet filter pairs to a set of data, either in one-dimension or in more than one-dimension. For image compression, a 2-D wavelet transform (i.e. horizontal and vertical) may be used. Further, for video compression, a 3-D wavelet transform (i.e. horizontal, vertical, and temporal) may be used.

Video compression methods traditionally do more than compress each image of the video sequence separately. Images in a video sequence are often similar to the other images in the sequence nearby from a temporal perspective. Thus, compression can be improved by taking this similarity into account. Doing so is called “temporal compression.”

One conventional method of temporal compression, used in MPEG, is referred to as motion search. With this technique, each region of an image being compressed is used as a pattern to search a range in a previous image. The closest match is chosen, and the region is represented by compressing only the difference from that match.

Another method of temporal compression may be carried out using wavelets, just as in the spatial (i.e. horizontal and vertical) directions, but also operating on corresponding pixels or coefficients of two or more images. This technique is often referenced to as 3D wavelets, for the three “directions” (i.e. horizontal, vertical, and temporal).

Temporal compression, by either method or any other, often requires the presence of an image and a previous image to be compressed together. In general, a number of images that are compressed together temporally is referred to as a Group of Pictures (GOP). Unfortunately, problems with the foregoing compression techniques arise in various compression applications. Prior art FIG. 1 just one example of such applications.

Prior art FIG. 1 illustrates a camera system 100 that may incorporate video compression, in accordance with the prior art. As shown, a plurality of cameras 102 are provided which, in turn, are coupled to a switcher 104 via feeds 103. In use, the cameras 102 operate as a plurality of sources of video which are fed to the switcher 104. Moreover, the switcher 104 operates to output (e.g. for display purposes, storage purposes, etc.) such video via an output 105.

Prior art FIG. 2 illustrates the manner in which the switcher 104 of FIG. 1 operates to select various feeds 103 from the cameras 102 to output the video, in accordance with the prior art. To accomplish this, the switcher 104 must select among the different feeds 103, as inputs, based on a field timing signal. Thus, the images from the cameras 102 are multiplexed, that is, transmitted one image at a time on a common video channel. In one example of use, two of the cameras 102 could be multiplexed by sending one video field from each camera 102 alternately. In another example, 15 cameras 102 could be captured twice per second each while a single other camera 102 is captured at a rate of 30 fields per second.

The multiplexed sequence of images described above is disadvantageous for video compression, especially temporal compression, because it reduces or eliminates the similarity between temporally adjacent images. While the similarity is still present between images from the same camera, conventional compression techniques cannot make use of this similarity due to the fact that such techniques can only exploit adjacent images or short groups of images.

There is thus a need for a temporal compression technique that overcomes these and/or other difficulties of the prior art.

There is still yet a further problem with compression of multiplexed video streams. Normally, there is some technique for adjusting the parameters of the compression process so as to keep the compression rate, or the output bit size per input image, approximately constant. This process is called “rate control.” The rate control process normally keeps some state from one image or GOP to the next. At a minimum, the encoding parameters used for the previous GOP are of use in setting the initial parameters for compression of the following GOP.

When images from multiple sources are interleaved for compression and even when they are temporally compressed using other known algorithms, however, the rate control may not work because the compression settings appropriate for a GOP from one source is likely to differ from those appropriate for a GOP from a different source.

There is thus a need for a compression rate controlling technique that overcomes these and/or other difficulties of the prior art.

### SUMMARY

A system, method, and computer program product are provided for temporal video compression. In use, portions of video are buffered in a first order. Further, the portions of video are at least partially temporally compressed in a second order.

In one embodiment, the portions of video may include frames, fields, half-fields, image information, etc. Further, the portions of video may be completely temporally compressed in the second order. To reduce the necessary storage required for the buffer, the portions of video may be at least partially compressed (e.g. non-temporally, etc.) prior to the buffering, after which the portions of video may be at least partially compressed temporally.

In another embodiment, the portions of video may be received from a plurality of sources. Such sources may be identified using identification information associated with the portions of video.

In use, it may be determined whether there are sufficient portions of video from at least one of the sources. Such determination may optionally be performed using a data structure that is associated with the number of portions of video from each of the sources. If it is determined that there are sufficient portions of video from at least one of the sources, the portions of video may be at least partially temporally compressed, in the manner set forth hereinabove.

Optionally, the portions of video that are oldest may be at least partially temporally compressed first. As yet another option, the portions of video from the plurality of sources may be buffered in a buffer pool.

Another system, method, and computer program product are further provided for compressing video from a plurality of sources. In use, video is received from a plurality of sources. Such video from the sources is then compressed. Such compression is carried out using a plurality of rate controls. In various embodiments, the video may be received by way of a single video stream, and/or the compression may be carried by way of a single compression module.

In one embodiment, separate rate control state memory may be provided for each of the plurality of sources. Still yet, the rate controls may be different for each of the sources. As an option, the sources may be identified using identification information associated with the video. By this feature, the rate controls associated with the sources may be identified upon receiving the video.

In use, the compression may be controlled based on the identified rate controls. Further, the rate controls may be updated after the compression. The purpose of such updating may vary, based on the mode in which the present embodiment is operating. For example, the rate controls may be updated for providing compression of a substantially constant quality, providing compression output with a substantially constant bit rate, etc.

### BRIEF DESCRIPTION OF THE DRAWINGS

Prior art FIG. 1 illustrates a camera system that may incorporate video compression, in accordance with the prior art.

Prior art FIG. 2 illustrates the manner in which the switcher of FIG. 1 operates to select various feeds from the cameras to output the video, in accordance with the prior art.

FIG. 3 illustrates a method for temporal video compression, in accordance with one embodiment.

FIG. 4A illustrates a system for providing temporal video compression, in accordance with one embodiment.

FIG. 4B illustrates a system for providing temporal video compression, in accordance with another embodiment.

FIG. 5 illustrates a method for providing temporal video compression, in accordance with another embodiment.

FIGS. 6A-6B illustrate methods for employing optional techniques in association with the method of FIG. 5.

FIG. 7 illustrates a method for compressing video from a plurality of sources, in accordance with one embodiment.

FIG. 8 illustrates a system for compressing video from a plurality of sources, in accordance with one embodiment.

FIG. 9 illustrates a method for compressing video from a plurality of sources, in accordance with another embodiment.

FIG. 10 illustrates a framework for compressing/decompressing data, in accordance with one embodiment.

### DETAILED DESCRIPTION

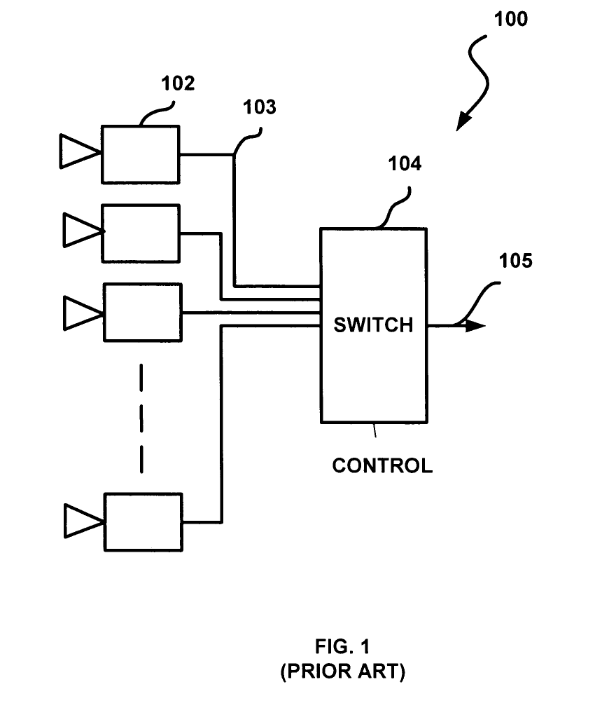

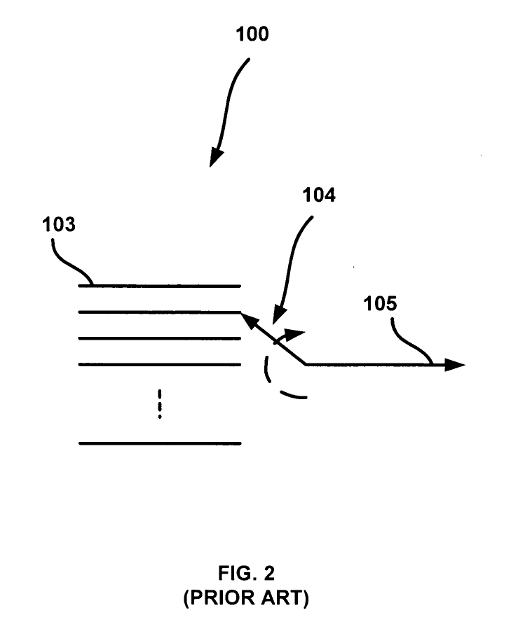

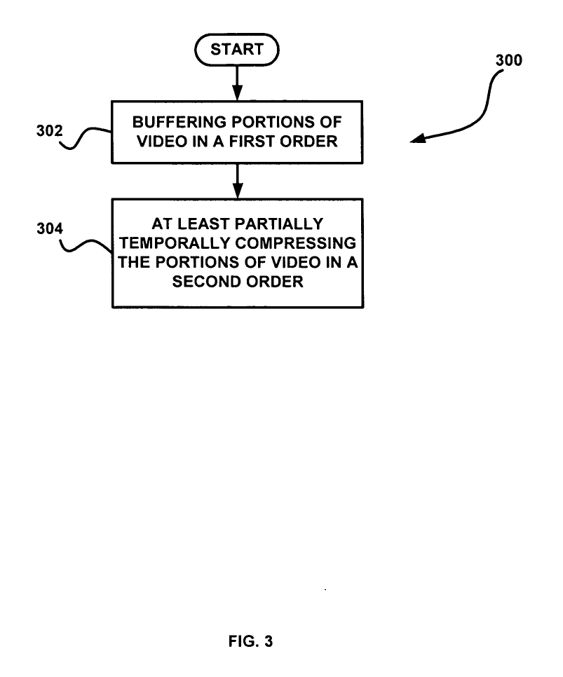

FIG. 3 illustrates a method 300 for temporal video compression, in accordance with one embodiment. As shown, in operation 302, portions of video are buffered in a first order. In the context of the present description, the portions of video may include frames, fields, half-fields, blocks, lines, image information, and/or absolutely any portion or part of the video.

In operation 304, the portions of video are at least partially temporally compressed in a second order. By this design, multiplexed portions of video may be temporally compressed since the order of the video portions may be different than the buffered order, such that the similarity among the video portions may be exploited. Of course, the foregoing method 300 is further beneficial in other contexts as well. Thus, it should be understood that the present technique may be applied in non-multiplexed environments as well.

More information regarding various exemplary implementations of the method 300 of FIG. 3 will now be set forth. It should be noted that such implementation details are set forth for illustrative purposes only and should not be construed as limiting in any manner.

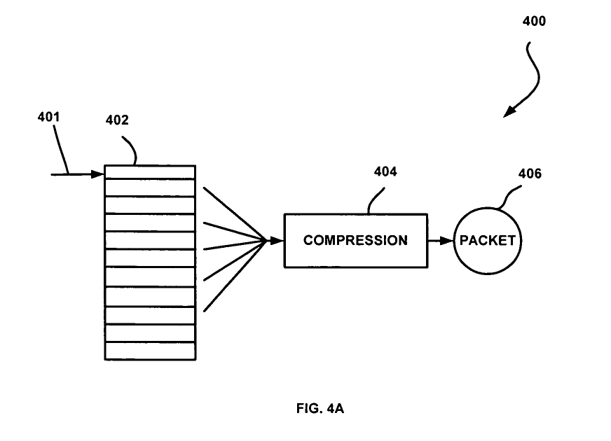

FIG. 4A illustrates a system 400 for providing temporal video compression, in accordance with one embodiment. Such system 400 may take various forms and, thus, should be construed as just one of many ways the method 300 of FIG. 3 may be carried out.

As shown, the system 400 includes a plurality of buffers 402 which are adapted for buffering portions of video received via a video input 401. Such buffers 402 may include absolutely any form of storage memory [e.g. random access memory (RAM), etc.]. The buffers 402 are, in turn, coupled to a compression module 404 which is capable of generating a compressed packet or file 406. In the context of the present description, the compression module 404 may include an encoder (of any type) and/or any type of hardware, software, logic, etc. that is capable of performing compression.

In use, the portions of video are received via a video input 401 and buffered in a first order using the buffers 402. For example, such first order may be as follows: Portion A, Portion B, Portion C, Portion D.

Since the portions of video may possibly be received from a plurality of sources, such sources may be identified using identification information associated with the portions of video, for reasons that will soon become apparent. Note for example, the following tagging scheme, in the context of the foregoing example: Portion A(source1), Portion B(source2), Portion C(source1), Portion D(source2).

Thereafter, the compression module 404 may, in turn, temporally compress the portions of video in a second order (which may be different from the first order). For example, in the context of the previous example, the second order may be as follows: Portion A, Portion C, Portion B, Portion D.

It thus becomes apparent that such different ordering allows portions of video from the same source to be adjacent, thus facilitating temporal compression. For example, in the context of the foregoing illustrative tagging scheme, the following order shows such adjacency: Portion A(source1), Portion C(source1), Portion B(source2), Portion D(source2).

There are numerous other optional features that may be incorporated with the foregoing system 400. For example, the portions of video that are oldest may be at least partially temporally compressed first. As yet another option, the portions of video from the plurality of sources may be buffered in a buffer pool (e.g. shared buffer, etc.). Thus, even if the video portions are received at different rates and irregular times, only a minimum amount of space is used. More information on such options will be set forth hereinafter in greater detail.

FIG. 4B illustrates a system 450 for providing temporal video compression, in accordance with another embodiment. Such system 450 may take various forms and, thus, should be construed as just one of many ways the method 300 of FIG. 3 may be carried out.

Similar to the system 400 of FIG. 4A, the system 450 includes a plurality of buffers 412 which are adapted for buffering portions of video received via a video input 411. The buffers 412 are, in turn, coupled to a compression module 414 which is capable of generating a compressed packet or file 416.

One paramount difference regarding the present system 450 with respect to system 400 of FIG. 4A is the inclusion of a second compression module 413 between the buffers 412 and the video input 411. In use, the portions of video may be at least partially compressed by the second compression module 413 prior to the buffering by the buffers 412, after which the portions of video may be at least partially compressed temporally using compression module 414.

It should be noted that the compression carried out by the second compression module 413 may, in one embodiment, include only non-temporal compression. Moreover, the compression carried out by the second compression module 414 may, in one embodiment, include at least temporal compression. Of course, any additional non-temporal compression may be carried out by the second compression module 414, etc.

To this end, the necessary storage required by the buffers 412 may be reduced by compressing, at least partially, the portions of video entering the same. While the above description assumes that the video portions are buffered “raw,” before any transform processing, this is not necessary. Transform processing normally does not mix together information from separate video portions before the temporal transform or motion search stage. This part of the processing, or some of it, can be done before storing the captured video portions.

By doing so, a partial compression is possible, and the stored information is smaller than the original raw video portions. If there is some compression before buffer storage, there may need to be some decompression before the remaining transform stages. It is not necessary to do a full compression on these intermediate video portions; the compression at this stage can be much simpler. In general, it is not necessary to decompress the intermediate image form completely into the same format as input digitized video.

For example, when processing video digitized to international standard ITU-R BT.656 (4:2:2 chroma sampling), the intermediate form may have the chroma components stored separately from the luma. It is usually preferable not to put them back into the BT.656 format before further block and temporal processing.

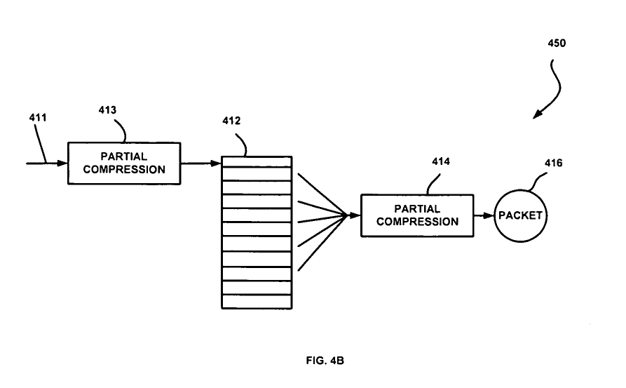

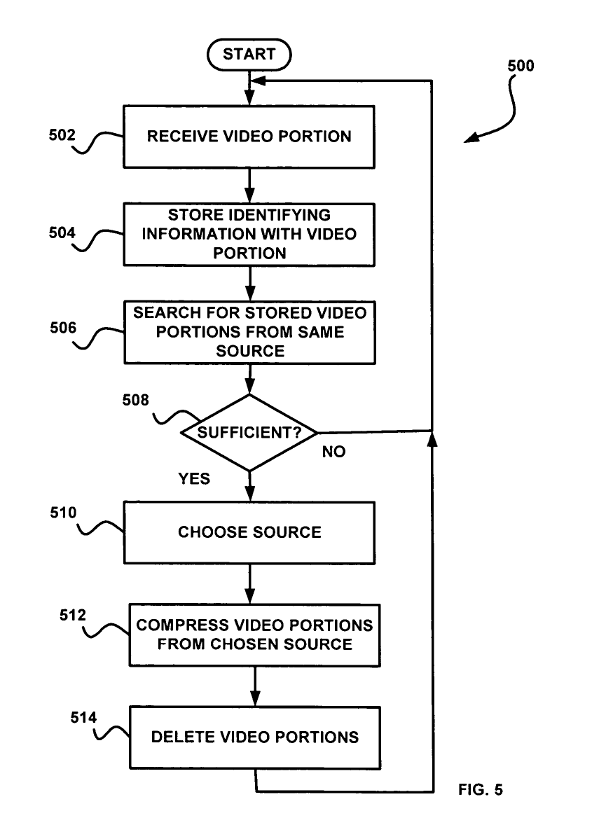

FIG. 5 illustrates a method 500 for providing temporal video compression, in accordance with another embodiment. Such method 500 may take various forms and, thus, should be construed as just one of many ways the method 300 of FIG. 3 and the systems of FIGS. 4A-4B may be carried out.

As set forth in operation 502, a digitized video portion is received together with identifying information about the video portion, which specifies at least which of a plurality of possible sources from which the video portion came. Next, the video portion is buffered together with the corresponding identifying information. Note operation 504. Such identifying information may include not only an identifier of the associated source, but also other optional data. For example, additional identifying information, such as a serial number or time code, may be included.

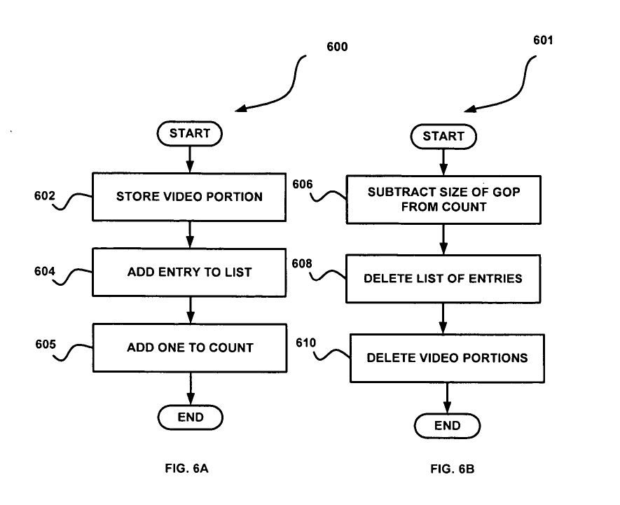

Thereafter, in operation 506, a search is performed involving the identifying information for all the stored video portions to find whether a sufficient number (i.e. a GOP) are present from any one source. This search can be made very efficient by tracking the identifying information in a particular data structure. More information regarding such option will be set forth during reference to FIG. 6.

It is then determined in decision 508 whether there are sufficient video portions from any one source. If not, operation continues with operation 502. If, however, it is determined in decision 508 that there are sufficient video portions from any one source, a source is chosen for which there are sufficient video portions stored. Note operation 510. Further, a GOP set of video portions is selected from such source. In one embodiment, the oldest stored video portions (i.e. the set stored longest) may be selected from such source.

Moving to operation 512, the video portions of the GOP are compressed together and transmitted as the compressed result. By buffering the video portions until there are several video portions from a single source, the video portions are taken for compression in a different order than the order they were delivered for compression. Finally, in operation 514, the video portions just compressed from storage are deleted.

FIG. 6A illustrates a method 600 for employing an optional technique in association with the method of FIG. 5, in accordance with one embodiment. Specifically, such method 600 may optionally be used in conjunction with operation 504 of the method 500 of FIG. 5.

The operation 504 of FIG. 5 may be made more efficient, if the stored information is maintained in the form of a set of lists, one for each source, and including a count for each source. Each list entry may contain a reference to the corresponding video portion storage location. When a video portion is stored, the associated identifying information may be used to add an entry to the list for the corresponding source, and the count for the given source may incremented. To this end, the search operation only has to check each of the source counts to find whether any of them is equal to or greater than the GOP size.

With such a data structure, the memory space for storing the video portion can be allocated dynamically. This means that storage space may be used only for sources that are actively supplying video portion, and that storage may be released for re-use as soon as possible. More information on the specific operations of such technique will now be set forth.

In operation 602, a video portion is stored in a memory location. Thereafter, in operation 604, an entry is added to the list for the source identified in the corresponding identifying information. As an option, a reference to the video portion location may further be stored in the new list entry. Also, in operation 605, one (1) is added to the count for the current source.

FIG. 6A illustrates a method 601 for employing an optional technique in association with the method of FIG. 5, in accordance with one embodiment. Specifically, such method 601 may optionally be used in conjunction with operation 514 of the method 500 of FIG. 5.

After compressing video portions from the chosen source, the size of a GOP is subtracted from the count for such source. Note operation 606. Thereafter, in operation 608, the list entries for the video portions of the GOP just compressed may be deleted. Finally, the video portions are deleted from memory in operation 610. Thus, memory area is made available for re-use.

Yet another optional feature of the present embodiment will now be set forth. The central problem that drives the choice of list management (as opposed to a vector per source, or a fixed number of buffers allocated to each source) is that it is difficult or impossible to predict how many video portion slots are required on a per source basis. On a pooled basis, it is clear (as long as the total input rate does not exceed the processing rate) that the maximum number of video portions that can be accumulated without having a full GOP for any source is N(G−1), where N is the number of sources and G is the maximum number of video portions in a GOP.

Therefore, the number of buffers required for operation is N(G−1)+1+P where P is the number of video portions required for actual processing (usually P=G). However, the maximum number of video portions accumulated for a given source may greatly exceed G due to conflicts for access to the processing. An example of such will now be set forth, for illustrative purposes.

In the present example, 4 sources, round-robin selection, and 4 video portions per GOP are utilized. As noted below in Table #1, the top line shows a source number of the input video portion, the second line shows a number of stored video portions for the source above, and the last line shows which source video portions are in the compression process at each time. At some time, no processing can be done because not enough video portions are present from any single source. Processing takes 4 cycles. In this model, video portions are removed from storage when their processing is completed.

TABLE #1

| | | | | | | | | | | | | | | | | | |
|---|---|---|---|---|---|---|---|---|---|---|---|---|---|---|---|---|---|
| In: | 1 2 | 3 4 | 1 2 | 3 4 | 1 2 | 3 4 | 1 2 | 3 4 | 1 2 | 3 4 | 1 2 | 3 4 | 1 2 | 3 4 | 1 2 | 3 4 | . . . |
| Number: | 1 1 | 1 1 | 2 2 | 2 2 | 3 3 | 3 3 | 4 4 | 4 4 | 1 5 | 5 5 | 2 2 | 6 6 | 3 3 | 3 7 | 4 4 | 4 3 | . . . |
| Total: | 1 2 | 3 4 | 5 6 | 7 8 | 9 10 | 12 | 14 | 16 | 14 | 16 | 14 | 16 | 14 | 16 | | 16 | . . . |

| | |
|---|---|
| Process: | 1_{———}2_{———}3_{———}4_{———} . . . |

With a list-per-source rather than a vector-per-source approach, the actual video portion storage can be pooled and the total required storage is significantly reduced. In the above example, although the maximum number of stored video portions at a time in the above sequence is 16, they are not evenly distributed among sources and a single source has up to 7 video portions stored.

A technique is thus provided by which temporal video compression may be applied with full effect to video information that is multiplexed from multiple sources of video portion sequences. This technique may further allow the application of higher-performance temporal motion compression where only lower-performance separate compression could be used before.

It should be noted that any aspect of the foregoing temporal compression technique may be employed in combination with any other technique set forth herein. For example, the foregoing temporal compression technique may optionally be used in combination with a rate controlling technique, which will now be set forth.

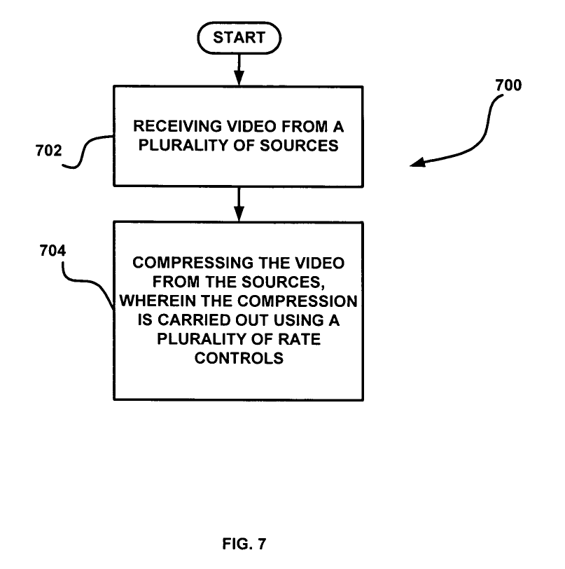

FIG. 7 illustrates a method 700 for compressing video from a plurality of sources, in accordance with one embodiment. As shown, in operation 702, video is received from a plurality of sources. In the context of the present description, the foregoing sources may each include a camera and/or absolutely any other source of video.

Next, in operation 704, such video from the sources is then compressed. It should be noted that the compression is carried out using a plurality of rate controls. Moreover, in various embodiments, the video may be received by way of a single video stream, and/or the compression may be carried by way of a single compression module. Again, in the context of the present description, the compression module may include an encoder (of any type) and/or any type of hardware, software, logic, etc. that is capable of performing compression.

To this end, when video portions from multiple sources are interleaved for compression, and even when they are temporally compressed using known algorithms, the rate control may still work because the compression settings appropriate for a GOP from one source are allowed to differ from those appropriate for a GOP from a different source.

More information regarding various exemplary implementations of the method 700 of FIG. 7 will now be set forth. It should be noted that such implementation details are set forth for illustrative purposes only and should not be construed as limiting in any manner.

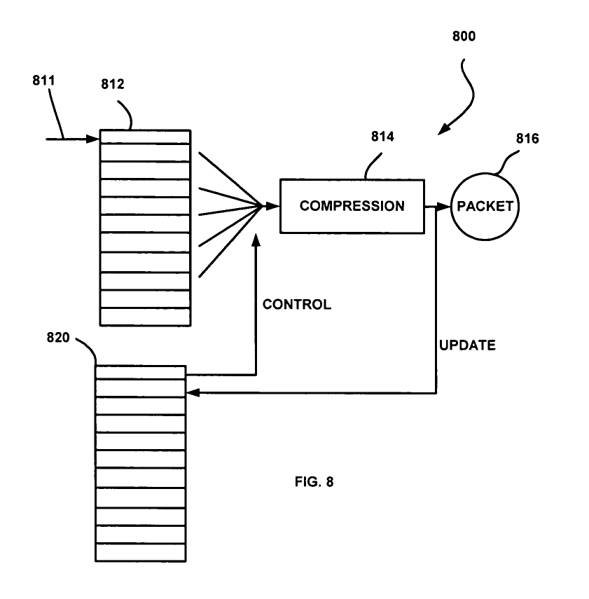

FIG. 8 illustrates a system 800 for compressing video from a plurality of sources, in accordance with one embodiment. Such system 800 may take various forms and, thus, should be construed as just one of many ways the method 700 of FIG. 7 may be carried out.

Similar to the various aforementioned systems of the previously described figures, the system 800 includes a plurality of buffers 812 which are adapted for buffering portions of video received via a video input 811. The buffers 812 are, in turn, coupled to a compression module 814 which is capable of generating a compressed packet or file 816.

Further included is a rate control data structure 820 for identifying rate control parameters each associated with one of the sources of the incoming video. It should be noted that the number of rate control parameters is the same as the number of sources. In use, such rate control parameters dictate the rate control that is carried out by the compression module 814 with respect to the video of the associated source.

Alternatively, the sources may be grouped such that one rate control parameter controls a group of similar sources. In this case, the number of rate control parameters is smaller than the number of sources. In use, such rate control parameters dictate the rate control that is carried out by the compression module 814 with respect to the video of each source in the associated group of sources.

Further during operation, the rate control parameters are fed to the compression module 814 with the associated video portions. Moreover, after compression, such rate control parameters may be updated, in a manner that achieves an overall compression result. This feedback-type updating of the rate control parameters may be tweaked for providing compression of a substantially constant quality, providing compression output with a substantially constant bit rate, etc.

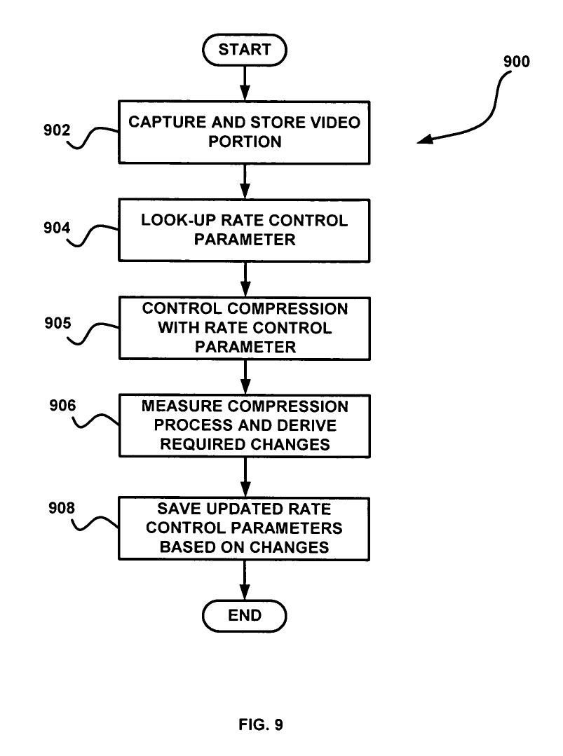

FIG. 9 illustrates a method 900 for compressing video from a plurality of sources, in accordance with another embodiment. Such method 900 may take various forms and, thus, should be construed as just one of many ways the method 700 of FIG. 7 and the system of FIGS. 8 may be carried out.

As shown, a video portion is captured in operation 902 and stored together with identifying information indicating the source from which this video portion came. Of course, additional identifying information, such as a serial number or time code, may also be included.

Next, the rate control state information corresponding to the source of this video portion may be looked-up. See operation 904. If the compression method requires a GOP of several video portions, this operation may be reserved for a case where sufficient video portions from the present source are present to enable encoding.

The state information looked up in operation 904 is then used to control the compression process, as indicated by operation 905. The compression process may further be measured to derive any needed changes in the rate control state parameters. See operation 906.

Finally, in operation 908, the rate control parameters may be updated in a location corresponding to the source of the video portion(s) just compressed, separate from the rate control parameters for any other source. Thereafter, the operations of FIG. 9 may be repeated, as desired.

A separate set of rate control state memory may thus be provided for each source of video, and the state corresponding to the source of the video portion or GOP may be used during compression. Thus, even though successive operations of the compression process operate on video portions from separate sources, which are likely to have very different statistical properties and very different rate control process state, one can apply rate control algorithms with assurance that each source is getting the control information appropriate to its history.

As yet another option, the aforementioned rate control technique may incorporate the rate control algorithm set forth in a provisional application entitled “Rate Control With Variable Sub-band Quantization” which was filed Sep. 22, 2004 under Ser. No. 60/______ and named the same inventors, and which is further incorporated herein by reference in its entirety.

More information will now be set forth regarding one particular exemplary environment in which the various techniques described above may be implemented. It should be noted, however, that such environment is set forth for illustrative purposes only and should not be construed as limiting in any manner.

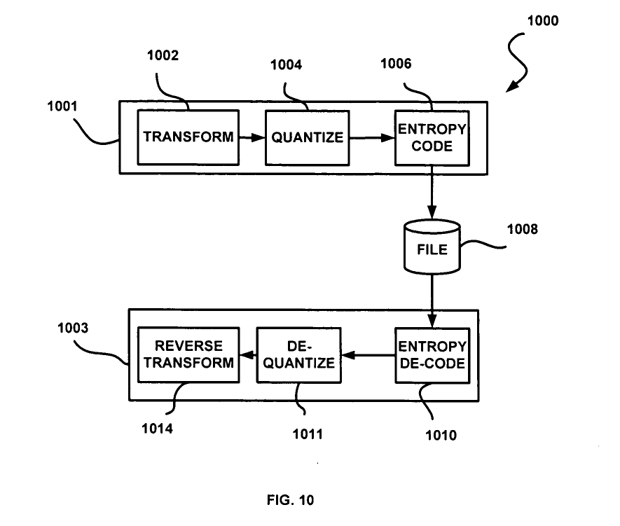

FIG. 10 illustrates a framework 1000 for compressing/decompressing data, in accordance with one embodiment. Included in this framework 1000 are a coder portion 1001 and a decoder portion 1003, which together form a “codec.” The coder portion 1001 includes a transform module 1002, a quantizer 1004, and an entropy encoder 1006 for compressing data for storage in a file 1008. To carry out decompression of such file 1008, the decoder portion 1003 includes a reverse transform module 1014, a de-quantizer 1011, and an entropy decoder 1010 for decompressing data for use (e.g. viewing in the case of video data, etc).

In use, the transform module 1002 carries out a reversible transform, often linear, of a plurality of pixels (e.g. in the case of video data) for the purpose of de-correlation. As an option, in one embodiment, the method 300 of FIG. 3 may be carried out in the context of the transform module 1002. Of course, however, it should be noted that the method 300 of FIG. 3 may be implemented in any desired context.

Next, the quantizer 1004 effects the quantization of the transform values, after which the entropy encoder 1006 is responsible for entropy coding of the quantized transform coefficients. The various components of the decoder portion 1003 essentially reverse such process. As an option, in one embodiment, the method 700 of FIG. 7 may be carried out in the context of the quantizer 1004. Of course, however, it should be noted that the method 700 of FIG. 7 may be implemented in any desired context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method for temporal video compression, comprising:
buffering portions of video in a first order; and
at least partially temporally compressing the portions of video in a second order.

2. The method as recited in claim 1, wherein the portions of video include frames.

3. The method as recited in claim 1, wherein the portions of video include fields.

4. The method as recited in claim 1, wherein the portions of video include half-fields.

5. The method as recited in claim 1, wherein the portions of video include image information.

6. The method as recited in claim 1, wherein the portions of video are completely temporally compressed in the second order.

7. The method as recited in claim 1, wherein the portions of video are at least partially compressed prior to the buffering.

8. The method as recited in claim 1, wherein the portions of video are at least partially temporally compressed in the second order after the buffering.

9. The method as recited in claim 1, wherein the portions of video are received from a plurality of sources.

10. The method as recited in claim 9, wherein the sources are identified using identification information associated with the portions of video.

11. The method as recited in claim 9, and further comprising determining whether there are sufficient portions of video from at least one of the sources.

12. The method as recited in claim 11, wherein the determination is performed using a data structure that is associated with the number of portions of video from each of the sources.

13. The method as recited in claim 11, wherein the portions of video are at least partially temporally compressed, if it is determined that there is sufficient portions of video from at least one of the sources.

14. The method as recited in claim 9, wherein the portions of video that are oldest are at least partially temporally compressed first.

15. The method as recited in claim 1, wherein the portions of video from the plurality of sources are buffered in a buffer pool.

16. A computer program product embodied on a computer readable medium for temporal video compression, comprising:
computer code for buffering portions of video in a first order; and
computer code for at least partially temporally compressing the portions of video in a second order.

17. A system for temporal video compression, comprising:
means for buffering portions of video in a first order; and
means for at least partially temporally compressing the portions of video in a second order.

18. A system for temporal video compression, comprising:
a buffer for buffering portions of video in a first order; and
an encoder in communication with the buffer, the encoder for at least partially temporally compressing the portions of video in a second order.

19. A method for compressing video from a plurality of sources, comprising:
receiving video from a plurality of sources by way of a single video stream; and
compressing the video from the sources;
wherein the compression is carried out using a plurality of rate controls.

20. The method as recited in claim 19, wherein separate rate control state memory is provided for each of the plurality of sources.

21. The method as recited in claim 19, wherein the rate controls are different for each of the sources.

22. The method as recited in claim 19, wherein the sources are identified using identification information associated with the video.

23. The method as recited in claim 19, wherein the rate controls associated with the sources are identified upon receiving the video.

24. The method as recited in claim 23, wherein the compression is controlled based on the identified rate controls.

25. The method as recited in claim 19, wherein the rate controls are updated after the compression.

26. The method as recited in claim 25, wherein the rate controls are updated for providing compression of a substantially constant quality.

27. The method as recited in claim 25, wherein the rate controls are updated for providing compression output with a substantially constant bit rate.

28. The method as recited in claim 25, wherein the rate controls are updated, in a first mode, for providing compression of a substantially constant quality, and, in a second mode, for providing compression output with a substantially constant bit rate.

29. A computer program product embodied on a computer readable medium for compressing video from a plurality of sources, comprising:
computer code for receiving video from a plurality of sources by way of a single video stream; and
computer code for compressing the video from the sources;
wherein the compression is carried out using a plurality of rate controls.

30. A system for compressing video from a plurality of sources, comprising:
means for receiving video from a plurality of sources by way of a single video stream; and
means for compressing the video from the sources;
wherein the compression is carried out using a plurality of rate controls.

31. A system for compressing video from a plurality of sources, comprising:
an encoder for receiving video from a plurality of sources by way of a single video stream, the encoder for compressing the video from the sources;
wherein the compression is carried out using a plurality of rate controls.

32. A method for compressing video from a plurality of sources, comprising:
receiving video from a plurality of sources; and
compressing the video from the sources;
wherein the compression is carried out using a plurality of rate controls, utilizing a single compression module.

33. The method as recited in claim 32, wherein separate rate control state memory is provided for each of the plurality of sources.

34. The method as recited in claim 32, wherein the rate controls are different for each of the sources.

35. The method as recited in claim 32, wherein the sources are identified using identification information associated with the video.

36. The method as recited in claim 32, wherein the rate controls associated with the sources are identified upon receiving the video.

37. The method as recited in claim 36, wherein the compression is controlled based on the identified rate controls.

38. The method as recited in claim 32, wherein the rate controls are updated after the compression.

39. The method as recited in claim 38, wherein the rate controls are updated for providing compression of a substantially constant quality.

40. The method as recited in claim 38, wherein the rate controls are updated for providing compression output with a substantially constant bit rate.

41. The method as recited in claim 38, wherein the rate controls are updated, in a first mode, for providing compression of a substantially constant quality; and, in a second mode, for providing compression output with a substantially constant bit rate.

42. A computer program product embodied on a computer readable medium for compressing video from a plurality of sources, comprising:
computer code for receiving video from a plurality of sources; and
computer code for compressing the video from the sources;
wherein the compression is carried out using a plurality of rate controls, utilizing a single compression module.

43. A system for compressing video from a plurality of sources, comprising:
means for receiving video from a plurality of sources; and
means for compressing the video from the sources;
wherein the compression is carried out using a plurality of rate controls, utilizing a single compression module.

44. A system for compressing video from a plurality of sources, comprising:
a single compression module for receiving video from a plurality of sources, the single compression module for compressing the video from the sources;
wherein the compression is carried out using a plurality of rate controls.

45. The method as recited in claim 19, wherein the rate controls are different for different groups of the sources.

46. The method as recited in claim 32, wherein the rate controls are different for different groups of the sources.
